(19) United States
(12) Patent Application Publication
(10) Pub. No.: US 2011/0151399 A1
(43) Pub. Date: Jun. 23, 2011

(54) METHOD AND TRANSFER ELEMENT FOR MANUFACTURING A SUPERSTRUCTURE AND A CORRESPONDING TEMPLATE

(76) Inventors: René De Clerck, Tervuren (BE); Ali Tahmaseb, Schoten (BE)

(21) Appl. No.: 13/061,326

(22) PCT Filed: Aug. 31, 2009
(86) PCT No.: PCT/BE2009/000048

§ 371 Date: Feb. 28, 2011

(30) Foreign Application Priority Data
Aug. 29, 2008 (BE) 20080483
Aug. 13, 2009 (BR) 20090495

(51) Int. Cl. A61C 19/04; A61C 11/00; A61C 8/00

(52) U.S. Cl. 433/75; 433/213; 433/201.1

(57) ABSTRACT

Method for manufacturing an aligning plate (3) with at least one opening (4) designed for drilling a bore hole (5) in a specific place in the bone of a lower or upper jaw (1) through said opening (4) to thus fix an implant (9,10) in the bore hole (5) in said bone in an oral cavity, whereby the position of said opening (4) in the aligning plate (3) and the position of the latter in the oral cavity are determined in relation to at least one reference organ (2) that is fixed to a tooth (12) situated in said lower or upper jaw (1).

The invention concerns a method for manufacturing a superstructure provided with false teeth which are mounted on at least one implant which is provided in a person's oral cavity and must be fixed in the bone of a lower or upper jaw, whereby an aligning plate is made with at least one recess so as to make a bore hole in the bone through the latter for mounting said implant.

The method used according to the state of the art for manufacturing an aligning plate and such a superstructure is very laborious. In a first stage, what is called a ‘fit-in-wax’ design is made of a dental prothesis by means of a mould taken of the patient's jaw. Next, a duplicate in synthetic resin is made of this ‘fit-in-wax’ design in which recesses are already provided corresponding to a possible position for the implants, in view of the bore holes to be made in the jaw. Of this duplicate must then be made what is called a CT scan while being placed on the patient's jaw concerned so as to determine the anatomical bone structure and the exact location of the nerve bundles and blood vessels. Thus is checked whether certain bores for the implants are possible, taking into account the anatomical structure of the jaw and the position of any present nerve bundles or blood vessels. If it is found that the proposed position of the implants is not appropriate, for example as nerve bundles or blood vessels would get hit when making bores, a new or an adapted design will have to be made.

Then, in a following step, an aligning plate is made on the basis of said duplicate, and the implants are put in place. After the implants have been put in place and the gums and bone have recovered from this operation, a number of moulds are taken from the jaw, together with the implants, so as to produce a superstructure. This superstructure must then be fit on the patient. On this superstructure are mounted false teeth.

In a variant of the preceding method, in the first step, a CT scan is made of the jaw on which the superstructure is to be fixed, and an aligning plate is made directly on the basis of the electronic information of said CT-scan. The superstructure is subsequently manufactured according to the technique described above.

In order to simplify this method, use can be made of reference points provided in the jaw's bone on the basis of which an aligning plate and a superstructure are made, as described in document WO 03/003933. However, this method is less indicated if only a few teeth are missing in the jaw.

If there are still some teeth in the jaw, they could also serve as a reference for manufacturing an aligning plate and/or a superstructure. However, since it is difficult to determine the exact position of teeth that are still present in a jaw with sufficient accuracy, they cannot be easily used to that end. Neither can the surface of these teeth be easily determined with sufficient accuracy.

The invention aims to remedy the above-mentioned disadvantages by proposing a method for producing an aligning plate which makes it possible, by means of any teeth present in a jaw, to make bore holes required for placing implants in a very simple and accurate manner. The aligning plate also makes it possible to place implants in a precise manner in the provided bore holes. Further, this method is advantageous in that it allows to determine the orientation and position of a reference point on a tooth with very great precision. The invention also aims to make it possible to place implants in the jaw as well as to mount a permanent dental prothesis on these implants in a single step.

To this aim, the position of said opening in the aligning plate and the position of the latter in the oral cavity is determined in relation to at least one reference organ, such that said bore hole can be drilled through said opening when the aligning plate has been positioned in the oral cavity, whereby a reference organ is fixed on a tooth situated in said lower or upper jaw.

Practically, the aligning plate is provided with a support to rest on the reference organ, so that, when the aligning plate rests on the reference organ with the support, said bore hole can be drilled through said opening.

According to a special embodiment of the method according to the invention, the aligning plate is provided with fixing means at or near the support so as to fix it in a detachable manner to a spherical bearing area of the reference organ, before said bore hole is made in the bone.

According to this special embodiment, the fixing means of the aligning plate preferably have an opening which connects almost precisely onto a feed-through opening provided in the reference organ, when the aligning plate rests on the bearing area of the reference organ, such that a bolt can be put through the latter which is screwed down in an internal screw thread in the feed-through opening of the reference organ.

According to a preferred embodiment of the method according to the invention, a dental mould is made of said jaw with said reference organ, and a provisional design of said superstructure with teeth is made on the basis of this mould, whereby a three-dimensional digital image is made of said jaw together with the provisional design and said reference organ.

In an advantageous way, said aligning plate is made on the basis of said three-dimensional image.

Preferably, said three-dimensional image is electronically processed so as to manufacture said aligning plate and/or said superstructure by means of what is called a prototyping technique.

According to an interesting embodiment of the method according to the invention, said aligning plate is fixed to said reference organ, whereby the jaw is being bored and the implant is fixed in the thus formed bore hole and, subsequently, said superstructure is mounted on the implant.

The invention also concerns a reference organ with fixing means for fixing it to the surface of a tooth, whereby it comprises a spherical bearing area with a centrally situated cylindrical feed-through opening to be used as a support for an aligning plate.

Preferably, said fixing means of the reference organ consist of, for example, a flat fixing plate which is glued onto the surface of a tooth, and said feed-through opening of the reference organ is provided with an internal screw thread.

The invention in general concerns a method for manufacturing an aligning plate with at least one opening designed to drill a bore hole in a particular place in the bone of a lower or upper jaw through said opening to thus fix an implant in the bore hole in said bone in an oral cavity. An image is generated hereby, representing a scan prothesis and critical anatomical structures of the jaw, and a desirable position and orientation for said implant is chosen on the basis of said image, such that when said bore hole is being drilled, no critical anatomical structures will be hit. Said position and orientation are determined in relation to a reference having a fixed position in relation to the bone of the jaw.

This method is characterised in that at least one reference organ is fixed to at least one tooth of the jaw, whereby the desired position and orientation of said implant is determined in relation to said reference organ and whereby fixing means are provided to the aligning plate for mounting it in a detachable manner to said reference organ.

According to this method, said opening is provided in the aligning plate and the position and orientation of said opening in relation to the fixing means are selected such that a bore hole can be made in the jaw whose position and orientation corresponds to the selected position and orientation of said implant when the aligning plate is fixed to said at least one reference organ.

Other particularities and advantages of the invention will become clear from the following description of some embodiments of the method, the transfer element and the reference organ according to the invention; this description is merely given by way of example and does not restrict the scope of the claimed protection in any way; the figures of reference used hereafter refer to the accompanying figures.

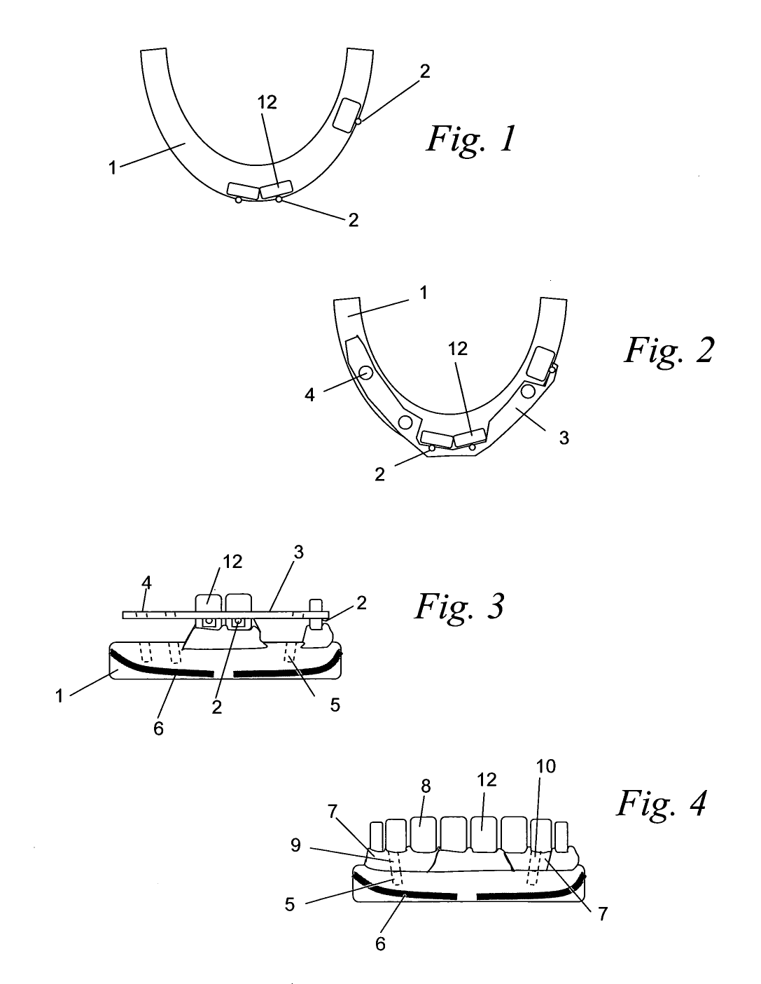

FIG. 1 is a schematic view from above of a part of a lower jaw with teeth and reference organs according to the invention.

FIG. 2 is a schematic view from above of a part of a lower jaw with an aligning plate according to the invention.

FIG. 3 is a schematic front view of the lower jaw and the aligning plate from FIG. 2.

FIG. 4 is a schematic front view of a part of a lower jaw with a superstructure provided with teeth according to the invention.

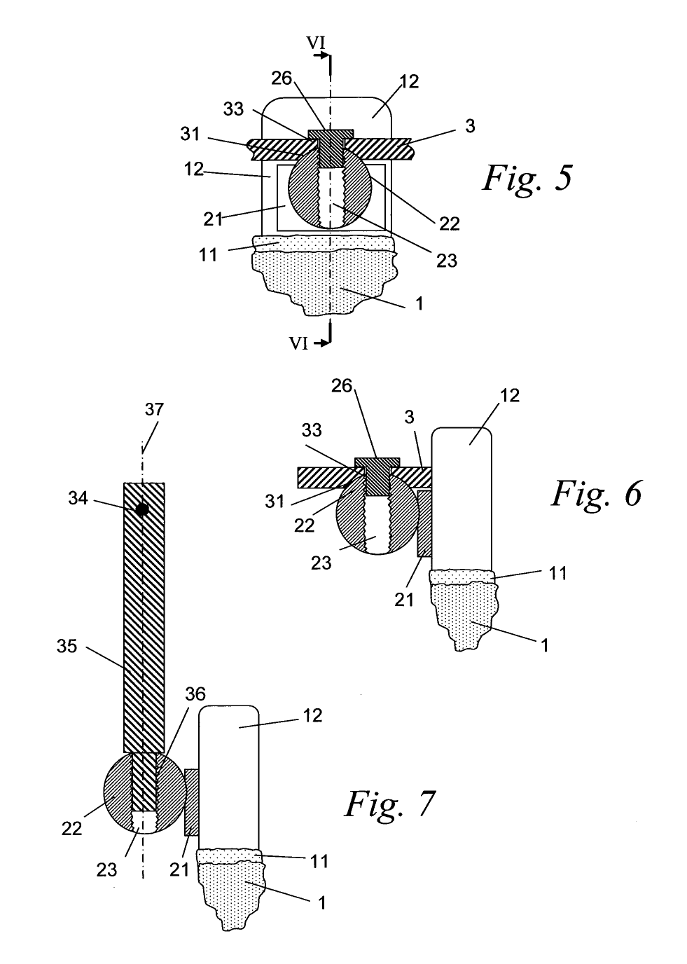

FIG. 5 is a schematic cross section of a reference organ together with an aligning plate which is fixed to a tooth according to the invention.

FIG. 6 is a schematic cross section according to line VI-VI of FIG. 5.

FIG. 7 is a schematic cross section as in FIG. 6, whereby a reference organ is provided with a marker according to the invention.

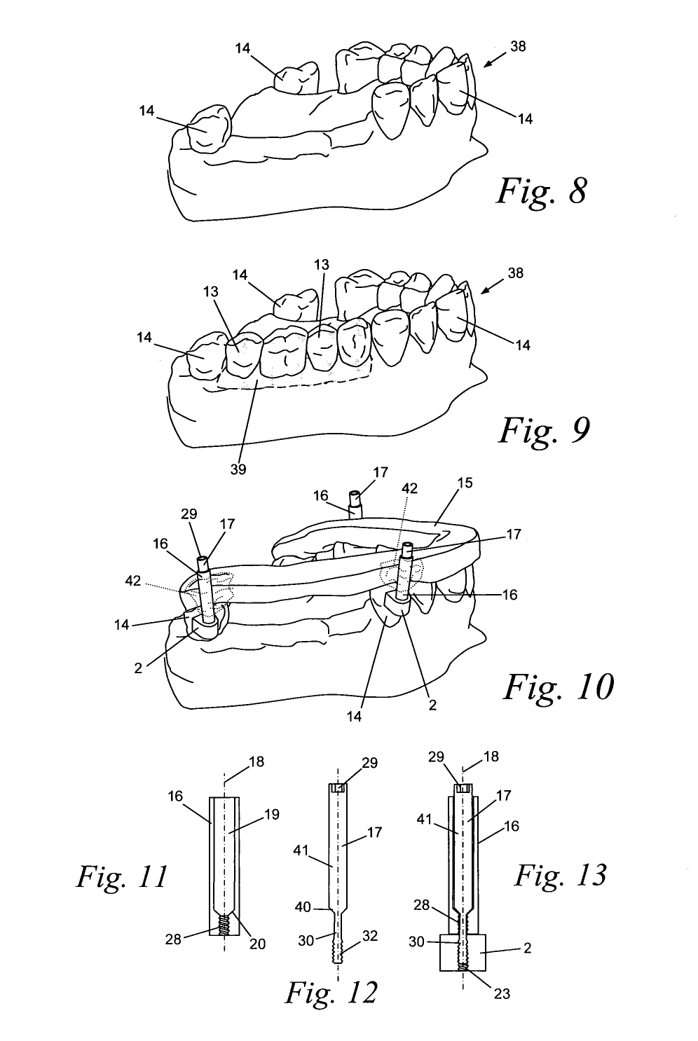

FIG. 8 is a schematic view in perspective of a physical model of a partially toothless jaw.

FIG. 9 is a schematic view in perspective of the model of the jaw from FIG. 8 on which is placed a scan prothesis.

FIG. 10 is a schematic view in perspective of the physical model of the jaw from FIG. 8 on which rests a transfer element and whereby reference elements are fixed to the teeth of this model.

FIG. 11 is a schematic longitudinal section of a transfer cylinder according to the invention.

FIG. 12 is a schematic longitudinal section of a screw for mounting the transfer cylinder from FIG. 11 according to the invention.

FIG. 13 is a schematic longitudinal section of a transfer cylinder with a screw and a reference organ according to the invention.

In the different figures, identical reference figures refer to identical or analogous elements.

The invention generally concerns a method for manufacturing a dental prothesis which needs to be fixed to what are called implants which are provided in a patient's jawbone. Such a dental prothesis comprises what is called a superstructure on which are provided false teeth in a manner known as such, and which also has fixing means so as to be fixed to said implants. The invention in particular concerns a method for manufacturing an aligning plate which makes it possible to carry out very precise bores in a simple manner in a patient's jaw, in relation to the teeth that are still present, in which said implants are to be placed.

The invention hereby also concerns a method to determine the position of at least one reference point on the present teeth in a jaw, making it possible to produce a dental prothesis which is to be fixed on said implants.

In order to produce such a dental prothesis by means of what are called ‘rapid prototyping’ techniques whereby for example the superstructure can be made directly from a piece of metal by means of a fully-automatic miller, a digital three-dimensional model of the jaw should preferably be made beforehand, indicating the exact positions of the reference points.

Such a three-dimensional digital model is obtained for example by making a CT scan (computed tomography scan) of the jaw or a digital scan, for example a laser scan, of a physical model of the jaw. Other imaging techniques are possible as well. The applied intra-oral imaging techniques make use of X-rays, such that implants, which are usually made of titanium, cannot be clearly discerned and do not produce a contrast that is sufficient to accurately determine any position. Neither teeth that are still present can be sufficiently clearly discerned to serve as a reference point and to be used for determining any position.

According to an interesting embodiment of the method according to the invention, reference organs 2 are fixed on some of the teeth that are still present 12 in the lower jaw 1 on which the superstructure is to be placed. FIG. 1 schematically represents a lower jaw 1 with a number of teeth 12 on which are provided reference organs 2 on three teeth 12.

According to a specific embodiment of the invention, each of these reference organs 2 is formed of a fixing plate 21 which is provided with a spherical bearing area 22.

These reference organs 2 are glued onto the surfaces of different teeth 12 of the jaw 1, above the gums 11, such that they can be easily removed again.

The spherical bearing area 22 is formed of a ball which is fixed to the fixing plate 21. There may also be a small, round stick situated between the fixing plate 21 and the spherical bearing area 22. The length of this stick is preferably relatively short, such that the spherical bearing area 22 is situated close to the tooth 12. Further, the diameter of the ball of the spherical bearing area 22 is for example in the order of some 2 to 5 mm. The spherical bearing area 22 is also provided with a central feed-through opening 23 which preferably runs practically parallel to the fixing plate 21. The reference organ 2 is glued onto a tooth 12 together with the fixing plate 21 in such a way that the feed-through opening 23 runs practically parallel to the tooth 12 and is practically perpendicular to the plane of the dental arch of the jaw 1.

According to the existing techniques, a mould is made of the jaw 1 and the teeth 12 with the reference organs 2 in order to make a physical model thereof. This physical model is also provided with a replica of the reference organ 2, whereby the position of this replica in the model is identical to the position of the reference organ 2 in relation to the tooth 12 and the jaw 1.

When producing a mould of the jaw 1 according to the existing techniques, a cylindrical sleeve is preferably provided over the spherical bearing area 22 of the reference organ 2, whereby a stick or bolt 26 is put through the cylindrical sleeve in the feed-through opening 23, such that said sleeve is positioned univocally in relation to the reference organ 2 and the tooth 12.

Next, according to a manner known as such, a dental mould is made of the jaw 1 together with the reference organs 2 and/or any sleeves or bolts 26 that may be provided thereon. By means of this mould is made what is called a bite plate which makes it possible to determine the position of the patient's upper jaw in relation to that of the lower jaw.

As, when forming said mould, said reference organs 2 with sleeves extend along the teeth 12, above the gums 11, corresponding cavities will be formed in the bottom side of the bite plate when forming said plate which make it possible to place the bite plate in an exact position in the oral cavity or on the physical model, whereby said cavities fit almost perfectly onto the sleeves, in which the reference organs 2 fit univocally and in which dummy reference organs 2′ can be placed with an analogous spherical bearing area 22′ and feed-through opening 23′. As a result, a physical model can be made including the dummy reference organs 2′ and whose position in relation to the model is identical to the position of the reference organ 2 in relation to the teeth 12 and the jaw 1.

By means of said bite plate and what is called an articulator, what is called a ‘fit-in-wax’ design is subsequently made forming a provisional design for the dental prothesis. This ‘fit-in-wax’ design has a relatively rigid bearing structure on which the false teeth are fixed with wax. The false teeth are made of a material which is clearly visible when making a CT scan. Thus, for example, a material containing barium will be used for the false teeth.

On the basis of this ‘fit-in-wax’ design is made a provisional prothesis whose teeth are thus clearly visible when generating a three-dimensional image by means of for example a CT scan. Also, such a provisional prothesis is called a scan prothesis.

Next, the scan prothesis is placed on the jaw 1 concerned in the patient's oral cavity, and a three-dimensional electronic image is made of the jaw 1 together with the scan prothesis and said reference organs 2. On each of the reference organs 2 may possibly be fixed a marker, as will be further described, so as to be able to determine the position of the reference organs 2 as accurately as possible. Such a marker produces a high contrast in images that are generated by means of X-rays.

In order to obtain said three-dimensional image, what is called a CT scan will be made for example. The information of this three-dimensional image is preferably processed electronically so as to be able to represent it in a simple manner, for example on a computer screen, and so that it can be used for certain prototyping techniques (what is called ‘rapid prototyping technique’).

From this three-dimensional image are derived the anatomical structure, the shape of the bone and the position of the nerve bundles and the blood vessels in the jaw 1. Next is determined in which positions and according to which orientation implants can be placed in the jaw 1 without touching nerve bundles, blood vessels or critical anatomical structures, whereby the position of the teeth in the scan prothesis is taken into account.

These desired positions and orientations of the implants are determined in relation to the reference organs 2.

On the basis of this information, taking into account the relative position of the reference organs 2 and the desired positions and orientations of the implants, an aligning plate 3 is made with openings 4 having an appropriate orientation and diameter, such that bores 5 can be made in the bone of the jaw 1 through the latter so as to mount said implants 9 and 10.

Apart from these openings 4, also fixing means are provided to mount the aligning plate 3 in a detachable manner to the spherical surface 22 of said reference organs 2. Thus is made sure that the position and orientation of said openings 4 in relation to said fixing means corresponds to the desired position and orientation of the implants in relation to the reference organs 2.

These fixing means in particular comprise recesses whose position corresponds to that of the feed-through opening 23 and which connect almost precisely to the latter. A bolt 26 is preferably used hereby to fix the aligning plate 3 in a detachable manner to each of the reference organs 2. The bolt 26 is preferably provided with a screw thread which fits in an internal screw thread of the feed-through opening 23.

In order to make said bores in the jaw, the aligning plate 3 is fixed to the jaw 1 via the reference organs 2 as is shown in FIGS. 2 and 3.

Thus, the position of said openings 4 is determined in relation to these reference organs 2 and the aligning plate 3 assumes a fixed position in relation to the teeth 12, the jaw 1 and the reference organs 2. This makes it possible to make a bore hole 5 for each implant to be placed by means of a drill, in a manner known as such. As mentioned above, the position and the orientation of said openings 4 are selected such that while drilling in the jaw 1, the blood vessels, the nerve bundles 6 or any other critical anatomical structures cannot be hit.

According to an advantageous embodiment of the method, the aligning plate 3 according to the invention is made by means of said prototyping techniques. Such techniques are for example stereo lithography, selective laser sintering, molten deposit modelling, laminated object manufacturing, three-dimensional printing, etc. According to a very interesting prototyping technique, said aligning plate 3 is made on the basis of the information of said three-dimensional image made by means of milling from for example a piece of metal or plastic.

Apart from said aligning plate 3, also the superstructure is made on the basis of said provisional design and said cavities corresponding to the position of said reference organs 2 on the one hand, and the relative position of said openings 4 in the aligning plate 3, i.e. the position of the implants in relation to the reference organs 2 on the other hand. The superstructure is preferably made by means of an analogous prototyping technique as the one that was used to produce the aligning plate 3.

Thanks to the use of said reference organs 2, it is no longer necessary to make a mould of a patient's jaw 1 after the implants have been put in place, and the superstructure can be made immediately on the basis of the information of said three-dimensional image.

On the basis of said physical model is made a superstructure 7 with the accompanying false teeth. To this end, this superstructure 7 is screwed on implants provided in the physical model by means of the aligning plate 3 and the corresponding reference organs 2 that are present in the physical model.

Next, the superstructure 7 is finished by fixing false teeth to it by means of plastic or porcelain. This concerns a conventional technique known to the professional, whereby a fit-in-wax model and a silicone key are most commonly used.

FIG. 4 schematically shows a thus manufactured superstructure 7 on which the false teeth 8 are represented when in place. This superstructure 7 has been mounted on implants 9 and 10 provided in the bores 5 in the lower jaw 1.

FIGS. 5 and 6 schematically show a reference organ 2 formed of a fixing plate 21 and a spherical bearing area 22. The reference organ 2 is glued with the almost flat fixing plate 21 to the front side of a tooth 12, above the gums 11, with adhesives known as such. Since the fixing plate 21 is glued on the enamel surface of the tooth 12, said reference organ can be easily removed again. The round bearing area 22 has a central feed-through opening 23 running practically parallel to the fixing plate 21 such that, when the latter is fixed to the tooth 12, the feed-through opening 23 is almost perpendicular to the plane of the dental arch of the jaw 1 concerned. The feed-through opening 23 is a cylindrical recess provided with an internal screw thread. In this feed-through opening 23 is fixed a bolt 26 making it possible to fix said aligning plate 3 to the bearing area 22.

As already mentioned above, the aligning plate 3 has a recess 33 in a position corresponding to that of the feed-through opening 23 in the bearing area 22 which connects almost precisely to the feed-through opening 23, whereby said recess has a cavity 31 resting on the top side of the spherical bearing area 22. Said bolt 26 extends through the recess 33 in the aligning plate 3 into the feed-through opening. However, the recess 33 must not necessarily have a cavity 31. Thus, the aligning plate 3 around the recess 33 may also be just flat.

As the bearing area 22 of the reference organ 2 is at least partly spherical, a relatively simple corresponding support can be provided on the aligning plate 3. If several reference organs 2 are used, the aligning plate 3 can, as a consequence, also be easily placed simultaneously on the different bearing areas 22 of the reference organs 2.

According to another method of the invention, a marker, known as such from document WO 2005/084576, is fixed to the reference organ 2. Said marker is characterised in that it produces a high contrast and is very precisely and clearly visible in the image being formed with X-rays.

The marker 34, as represented in FIG. 7, is fixed to the reference organ 2 in a specific position and at a certain distance, such that its position in relation to the reference organ 2 is univocally determined.

To this end, the marker 34 is provided for example in a support 35 in the shape of, preferably, a cylindrical stick with a screw thread 36 on one far end with which it is fixed in a detachable manner in the feed-through opening 23 in the spherical surface 22 of the reference organ 2. Thus, after having been mounted, the stick extends coaxially in relation to the feed-through opening 23.

The other far end of the stick contains said marker 34. The latter is preferably spherical with a diameter of between 1 and 3 mm, for example, whereby its centre is situated practically on the longitudinal axis 37 of the cylindrical stick. The distance between the marker and the far end of the stick, which is to be fixed to the reference organ 2, is thereby known exactly.

Advantageously, the distance between said marker 34 and the far end of the support 35 which is to be connected to the bearing area 22 of the reference organ 2 when being fixed to it will be measured.

Said support 35 is preferably made of a material which is to a large extent transparent to X-rays.

In order to thus determine the position of the reference organ 2 in relation to the jaw 1 in which it has been placed, said support 35 is fixed with the marker 34 to the bearing area 22 of the reference organ 2. Next, an X ray is made, in particular a three-dimensional image, of the jaw 1 with the reference organ 2 and the marker 34, for example by making a CT-scan as mentioned above.

The thus obtained three-dimensional image produces a very sharp image of the marker 34, since the latter has a high X-ray absorption, and the exact position and orientation of the reference organ 2 in relation to the jaw 1 and tooth 12 are determined in this manner. Thus, also the position of the bearing face 22 and the feed-through opening 23 of the reference organ 2 can be determined in relation to the jaw 1.

In a variant of this embodiment of the invention, the marker 34 is used as a reference in said three-dimensional image for manufacturing the aligning plate and the superstructure, or the reference organ 2 is provided with a marker 34.

The above-described method can also be applied to said physical model. Thus is avoided that markers need to be provided in a patient's oral cavity. A three-dimensional electronic image of the physical model with the reference organs and the markers is generated hereby, and possibly the scan prothesis by means of a CT scan or possibly by means of laser scanning.

The precise positioning of the reference organs 2 in relation to the jaw 1 with for example a CT scan makes it possible to produce an aligning plate 3 on the basis of a computer scan model for placing implants 9 and 10 and for fixing a superstructure 7.

Said implants 9 and 10 can be provided for example on said physical model on which can subsequently be formed a superstructure 7 with false teeth.

Further, when generating a three-dimensional image of a patient's jaw 1 together with a provisional design of a scanable prothesis that has been placed on the jaw 1, the position of the reference organs 2 can also be determined by fixing the above-mentioned markers onto them. Thus is obtained a digital image of the jaw 1 with false teeth and reference organs 2. This produces univocally fixed reference points by means of which an aligning plate can be made, and thus a choice can be made regarding the position and orientation of the implants to be placed.

By making an entirely digital model of the jaw 1, the reference organs 2 and possibly the scan prothesis, it becomes possible to virtually determine a desired position of the implants.

Alternatively, the entire prothesis with false teeth and implants can be virtually designed in a computer model on the basis of the exact location of the reference organs 2 in relation to the jaw 1 and critical anatomical structures 6 in the jaw 1.

According to another embodiment of the method according to the invention, use is made of a transfer element to produce an aligning plate 3 for making bore holes 5 in the jaw 1 to place implants 9 and 10 in.

To this end, a mould of the patient's jaw 1 concerned is preferably made in a first step so as to make a physical model 38 of the jaw 1. Such a physical model 38 is represented in FIG. 8 and is made of plaster, for example.

By means of this physical model 38 and, normally, a bite plate and a model of the opposite jaw, the dental technician will then make what is called a scan prothesis 39, made in a manner known as such, with the aid of a ‘just in wax’ model. This scan prothesis 39 forms a radio opaque model of the desired teeth arrangement for the definitive prothesis, and it is represented in FIG. 9.

The scan prothesis 39 represented in this figure is provided with teeth 13 that are radio opaque and which are made for example of a mixture of barium sulphate and a synthetic resin.

Further, reference organs 2 are provided on the teeth 14 of the physical model 39 by gluing them for example on the lateral face of the teeth 14. In the example represented in FIG. 10, a reference organ 2 is fixed to three teeth 14 of the physical model 38.

Apart from that, what is called a transfer element 15 is made which makes it possible to apply reference organs 2 on the teeth 12 in the patient's oral cavity, whereby the relative position of the reference organs 2 in the oral cavity in relation to the teeth of the jaw is identical to that of the reference organs 2 in the physical model 38.

The transfer element 15 is formed by placing a strip of kneadable plastic on the top of the teeth 14 of the physical model 38 and by exerting a light pressure on it in relation to these teeth 14, such that the relief of the top of the teeth 14 is pressed into the plastic. Thus is obtained a mould of the top of the teeth 14. Hereby is made sure that the strip of plastic extends over at least the teeth 14 onto which has been fixed a reference organ 2.

Next, the strip of plastic of the transfer element 15 is made to cure so as to obtain an almost non-deformable whole that can be placed in a fitting manner on the top of the teeth 14.

On the reference organs 2 which are fixed to the teeth 14 of the physical model 38 is mounted a transfer cylinder 16 by means of a tall screw 17. This is done in such a manner that there will be practically no play between the transfer cylinder 16 and the respective reference organs 2. The transfer cylinder 16 and said screw 17 thus form a position transfer organ.

FIG. 11 shows a cross section of a transfer cylinder 16 according to the central axis 18 thereof. This transfer cylinder 16 is axially symmetrical and has a cylindrical body in which has been axially provided a cylindrical recess 19 over its entire length. On one far end of the transfer cylinder 16, the cylindrical recess 19 has a conical collar 20 which turns into a cylindrical narrowing 28 of the recess 19 provided with screw thread.

A cross section of said screw 17 is represented in FIG. 12. This screw 17 is formed of a stick 30 of which one far end is provided with screw thread 32. The other far end of this stick 30 connects onto a coaxial cylindrical body 41 with a larger diameter via a conical transition piece 40. On the far end opposite the transition piece 40, said body has a recess 29 in the shape of a hexagonal prism in which a tool can be inserted to drive the screw 17 round its central axis.

In order to thus fix the transfer cylinder 16 to a reference organ 2 concerned, the screw 17 is put in the recess 19 of the transfer cylinder 16, whereby the stick 30 is screwed in the feed-through opening 23 of the reference organ 2 by means of its screw thread 32, as is represented in FIG. 13. The screw 17 is hereby tightened until the reference organ 2 rests against the corresponding far end of the transfer cylinder 16, whereby the conical transition piece 40 of the screw 17 rests in the conical collar 20 of the transfer cylinder 16. In this way, the screw 17 and the transfer cylinder 16 extend coaxially, whereby the position of the reference organ 2 is univocally determined in relation to the transfer cylinder 16.

On each of the reference organs 2 of the physical model 38 is mounted a transfer cylinder 16 in this way. As is shown in FIG. 10, the transfer element 15 is then placed in a fitting manner on the top of the teeth 14 of the model 38, and the transfer cylinders 16 are permanently fixed to said transfer element 15 by means of a curing plastic or glue 42.

In order to provide reference organs 2 on the teeth 12 in the oral cavity in a position corresponding to that of the reference organs 2 in the model 38, the transfer element 15 with the transfer cylinders 16 is detached from the physical model 38 by unscrewing the screws 17 or the reference organs 2 concerned.

To the transfer cylinders 16 are then fixed loose reference organs 2 by means of said screws 17, and the transfer element 15 is placed in a fitting manner, together with these reference organs 2, on the teeth 12 in the patient's oral cavity. The reference organs 2, which are fixed to the transfer element 15, are permanently connected to the corresponding teeth 12 in the patient's oral cavity by means of a curing plastic or glue.

Next, the transfer element 15 with the transfer cylinders 16 is detached from the reference organs 2 and removed from the oral cavity, and said scan prothesis 39 is placed in a fitting manner in the jaw concerned in the oral cavity. On each of the reference organs 2 in the oral cavity is fixed a marker 34.

Then, a three-dimensional image is made of the jaw together with the scan prothesis 39 and the markers 34. This image is obtained for example by making a CT scan.

The three-dimensional image is electronically or digitally processed and preferably represented on a computer screen. This image clearly shows the position of anatomical structures 6, such as nerve bundles, in relation to the markers 34 and in relation to the teeth 13 of the scan prothesis 39. Thus is selected an optimal position and orientation of the implants to be provided, reckoning with the position of the teeth 13 of the scan prothesis 39, the bone structure of the jaw 1 and the position of anatomical structures 6 in the jaw.

The selected position and orientation of the implants is defined in relation to the markers 34 or in relation to the reference organs 2 which are permanently fixed to the markers 34.

Next, an aligning plate 3 is made by means of a prototyping technique (what is called a ‘rapid prototyping technique’). The mutual position of the reference organs 2 or markers 34 and the desired position and orientation of the implants in relation to these reference organs 2 or markers 34 are hereby taken as a basis. The aligning plate 3 is milled for example out of a piece of metal or plastic by means of a digitally controlled miller.

Thus, an aligning plate 3 is produced with fixing means to mount the aligning plate 3 on the reference organs 2 and with openings 4 to guide a drill for drilling bore holes 5 in the jaw. The position and orientation of the openings 4 in relation to the fixing means is thus selected such that they make it possible to drill bore holes 5 in the jaw whose position and orientation corresponds to the selected position and orientation of the implants when the aligning plate 3 is fixed to the reference organs 2. Further, the openings 4 also make it possible to guide an implant when placing it in the bore hole 5 provided to that end in the jaw.

Said fixing means are formed for example of a recess 33 which must connect to the feed-through opening 23 of the reference organs 2 and which makes it possible to mount the aligning plate 3 with bolts 26 on the reference organs 2.

Apart from that, on the basis of the digital information of said three-dimensional image and the selected position of the implants in relation to the reference organs 2 or in relation to the markers 34, a superstructure is made by means of a prototyping technique. The superstructure is milled for example out of a piece of titanium.

In order to finish the superstructure 7 and provide false teeth 8 on it, the aligning plate 3 is mounted on the reference organs 2 of the physical model 38. Next, bore holes 5 are drilled in the physical model 38 by means of the aligning plate 3, and replicas or the implants which are to be placed in the patient's jaw are fixed therein.

Then, the teeth 8, which are made for example on the basis of a plastic or porcelain, are placed on the superstructure 7 and the dental prothesis is finished according to a manner known as such to the dental technician.

After the superstructure 7 with the dental prothesis is finished, the aligning plate 3 is mounted on the reference organs 2 in the patient's oral cavity. Next, the bore holes 5 for the implants are drilled in the jaw by consecutively guiding different drills with an increasing diameter through the openings of the aligning plate 3 in a known manner. The implants are then mounted in these bore holes 5. This can be done for example in a manner as described in document WO 2008/009080 in order to place the implants exactly in the selected position, in particular at a correct depth in the jaw.

As soon as the implants have thus been fixed in the patient's jaw, the aligning plate 3 is removed from the oral cavity and the reference organs 2 are detached from the teeth 12. Next, the superstructure 7 can be immediately screwed on the implants in a fitting manner.

According to a variant of the preceding embodiment of the method according to the invention, it is of course possible to first fix the reference organs 2 to the teeth 12 in the patient's oral cavity and to subsequently attach reference organs 2, by means of said transfer element 15, to the teeth 14 of the physical model 38.

In another variant of this embodiment of the method according to the invention, at least one reference organ 2 is fixed to the scan prothesis 39. Said three-dimensional image is then made without having to provide any reference organs 2 on the teeth 12 of the patient's jaw. This image also makes it possible to select a position and orientation for the implants in relation to the reference organ 2 which is fixed to the scan prothesis 39.

Next, the scan prothesis 39 is placed in a fitting manner on the physical model 38, and a transfer element 15 as described above is made. Said transfer cylinders 16 are then mounted on the reference organs 2 of the model 38 and of the scan prothesis 39 and they are subsequently attached to the transfer element 15.

Said markers 34 are then fixed on the reference organs 2 of the model 38 and of the scan prothesis 39, and a second three-dimensional image is generated of the model 38 together with the scan prothesis 39, for example by means of a CT scan or a laser scan.

By combining both three-dimensional images, taking into account the position of the reference organs 2 which are fixed to the scan prothesis 39, it becomes possible to produce an aligning plate 3 provided with fixing means so as to mount them on the reference organs 2 of the physical model 38. In particular, the information of both three-dimensional images in relation to the reference organs or markers is used to produce the aligning plate.

By means of the transfer element 15, reference organs 2 are then fastened to the teeth 12 in the patient's oral cavity in positions corresponding to those of the reference organs 2 which are fixed to the teeth 14 of the physical model 38.

In order to form said bore holes 5 and to place the implants, the aligning plate 3 is mounted on the reference organs 2 in the patient's oral cavity.

The latter variant of the method according to the invention is advantageous in that reference organs 2 are only present in the patient's oral cavity for a limited length of time.

Moreover, in certain cases it is possible not to provide any reference organs 2 when making a three-dimensional image of the patient's jaw. In that case, the selected position of the implants is defined in relation to the scan prothesis 39 or in relation to certain teeth 13 of the latter.

When manufacturing the transfer element 15, it is then made sure that it also connects in a fitting manner to the teeth 13 of the scan prothesis 39. Next, as described in the preceding variant of the method, a three-dimensional image of the scan prothesis is also made together with the physical model 38 on which markers 34 are provided which are fixed to the reference organs of the teeth 14 of the model 38.

Both three-dimensional images are then combined, taking into account the position of the teeth 13 of the scan prothesis 39 so as to produce the aligning plate 3.

According to yet another variant of the method according to the invention, the teeth 13 of the scan prothesis 39 are permanently connected to the transfer element 15. A material is hereby selected for the transfer element 15 which is not radio opaque, whereas the teeth 13 of the scan prothesis as described above are radio opaque indeed.

Thus, the transfer element 15 together with the scan prothesis 39 is placed in the oral cavity when generating a three-dimensional image of the jaw. In this image can then be observed the jaw bone, the teeth of the scan prothesis and anatomical structures of the jaw, such as nerve bundles.

By means of this three-dimensional image is then selected an optimal position and orientation for the implants to be provided. This position and orientation of the implants is defined in relation to the image of the teeth of the scan prothesis.

Further, the transfer element 15 together with the teeth 13 of the scan prothesis are placed on said physical model 38, and the transfer element 15 is connected to the reference organs 2 which are fixed to the physical model 38 as described above. A second three-dimensional image is then made of the whole. This second image shows the teeth 13 of the scan prothesis, as well as the position of the reference organs 2. Markers 34 may be possibly fixed to the reference organs 2 to that end.

By combining the information of both three-dimensional images, the relative position of the openings 4 in the aligning plate 3 to be made can be determined in relation to the reference organs 2, or in particular in relation to supports 33 via which the aligning plate must be fixed to the reference organs 2, as is the case in the other embodiments described above. Thus, on the basis thereof, as already described above, an aligning plate 3 is made with openings 4 whose position and orientation is determined in relation to the supports 33.

Naturally, radio opaque elements can also be provided in the transfer element 15 itself, whereby the position and orientation of the implants to be provided is then defined in relation to said radio opaque elements.

According to another interesting application of the invention, the reference organs 2 are used for orthographic surgery. Said reference organs 2 are hereby provided for example on the teeth of a lower and an upper jaw. By means of a marker 34 can then be made a digital model as described above, by means of a CT scan, of the jaws in which the reference organs 2 are situated. Thus, these reference organs 2 can be used to reposition the jaws in relation to one another.

These reference organs 2 can also be used, for example, to repair the shape of a jaw after an accident.

According to yet another interesting method of the invention, said reference organs 2 can be used for producing a straightening jig and to also position it in relation to these reference organs 2. The straightening jig thereby serves to direct an X-ray source to a specific place, such that a local and directional radiation can be produced with great accuracy at a tumour.

The advantage of this reference organ 2 is that it can be placed rather easily on a tooth and can also be easily removed from it. Further, by means of the above-described techniques, it is possible to determine the exact location thereof, such that for example an aligning plate can be designed which, as it rests on the standardised bearing area of the reference organ, can be put in an exact position in the oral cavity.

The invention is by no means restricted to the above-described embodiments of the method, the superstructure, the transfer element, the aligning plate and the reference organ according to the invention and as represented in the drawings; on the contrary, several variants may be conceived within the scope of the invention as far as the reference organs as well as the dimensions and shapes of the aligning plate are concerned.

Although a superstructure has been described in the preceding description and in the accompanying drawings which is fixed to a lower jaw by means of two implants, the invention also concerns a method and an aligning plate whereby three or more implants are provided in the lower jaw or whereby only one implant is used. Moreover, apart from a reference organ which is fixed to a tooth, also an additional reference organ can be used which has been fixed in the jaw bone, such as for example an existing implant. Although in the preceding embodiments of the method according to the invention, three reference organs are used, it is also possible to apply the method with one, two or more than three reference organs. Further, the invention can also be applied for manufacturing and mounting an aligning plate and/or superstructure for an upper jaw. Further, the spherical bearing area of the reference organ may be connected to the fixing plate by means of a somewhat longer stick, and/or thus the feed-through opening can be made somewhat slantingly, such that it is more accessible for fixing an aligning plate. This bearing area must not necessarily be spherical, but it may also be partly spherical or even entirely flat. Other shapes are possible as well for this surface, such as for example an at least partly conical shape.

1. Method for manufacturing an aligning plate (3) with at least one opening (4) designed for drilling a bore hole (5) in a specific place in the bone of a partly teethless lower or upper jaw (1) through said opening (4) to thus fix an implant (9,10) in the bore hole (5) in said bone in an oral cavity,
whereby an image is generated representing a scan prothesis (39) and critical anatomical structures (6) of the jaw (1);
whereby a desired position and orientation for said implant (9,10) is selected starting from said image, such that when drilling said bore hole (5) no critical anatomical structures (6) may get hit and whereby the position and orientation are determined in relation to a reference having a fixed position in relation to (the bone of) the jaw (1);
characterised in that at least one reference organ (2) is fixed to at least one tooth (12) of the jaw (1), whereby the desired position and orientation of said implant (9,10) is determined in relation to said reference organ (2);
whereby fixing means are provided on the aligning plate (3) so as to mount it in a detachable manner to said reference organ (2);
whereby said opening (4) is provided in the aligning plate (3) and the position and orientation of said opening (4) in relation to the fixing means are selected such that it becomes possible to drill a bore hole (5) in the jaw (1) whose position and orientation corresponds to the selected position and orientation of said implant (9,10) when the aligning plate (3) is fixed to said at least one reference organ (2).

2. Method according to claim 1, whereby the aligning plate (3) is provided with a support (33) to rest on the reference organ (2) such that when the aligning plate (3) rests on the reference organ (2) with the support (33), said bore hole (5) can be drilled through said opening (4).

3. Method according to claim 1 or 2, whereby the aligning plate (3) is provided with fixing means to fix them in a feed-through opening (23) of the reference organ (2).

4. Method according to claim 3, whereby the fixing means of the aligning plate (3) comprise an opening (31) which connects almost precisely to the feed-through opening (23) when the aligning plate (3) rests on the bearing area (22) of the reference organ (2), such that a bolt (26) can be provided through it which is screwed down in an internal screw thread in the feed-through opening (23) of the reference organ (2).

5. Method according to any one of claims 1 to 4, whereby a dental mould is made of said jaw (1) with said reference organ (2) and a scan prothesis or a provisional design is made of a superstructure (7) with false teeth on the basis of said mould, whereby a three-dimensional image is made of said jaw (1) together with the scan prothesis of the provisional design and said reference organ (2).

6. Method according to claim 5, whereby said aligning plate (3) is made on the basis of said three-dimensional image.

7. Method according to any one of claims 5 to 6, whereby said three-dimensional image is electronically processed so as to produce said aligning plate (3) and/or said superstructure (7) by means of what is called a prototyping technique.

8. Method for manufacturing a superstructure (7) with false teeth (8) which is to be mounted on at least one implant (9,10) in an oral cavity, which implant (9,10) is placed in a corresponding bore hole (5) which is to be drilled in the bone of an upper or lower jaw (1) in which teeth (12) are present, characterised in that a reference organ (2) is fixed to at least one tooth (12) of the jaw (1) and in that a reference organ (2) is fixed to a corresponding tooth (14) of said physical model (38), whereby the position of the reference organ (2) in the jaw (1) in relation to the latter is identical to the position of the reference organ (2) in the physical model (38) in relation to said model (38), whereby an aligning plate (3) is mounted on the reference organ (2) of the physical model (38) so as to drill a bore hole (5) in the model (38), whereby an implant (9,10) is placed in this bore hole (5) in the model (38) and said superstructure (7) is fixed to this implant (9,10) and false teeth (8) are subsequently provided on the superstructure (7).

9. Method according to claim 8, whereby a transfer element (15) is made which can be placed univocally and in a precisely fitting manner on the jaw (1) and on the physical model (38),
whereby a position transfer organ (16,17) is fixed to the reference organ (2) provided on the jaw (1), or on the physical model (38) respectively, and is subsequently connected to the transfer element (15),
whereby the position transfer organ (16,17) is subsequently detached from the reference organ (2) concerned and a free reference organ (2) is fixed to the position transfer organ (16,17), and
whereby the transfer element (15), together with the position transfer organ (16,17) and the free reference organ (2) fixed to the latter, is then placed in a fitting manner on the physical model (38), or on the jaw (1) respectively,
whereby the free reference organ (2) is then connected to a tooth (14) of the physical model (38), or to a tooth (12) of the jaw (1) respectively, and is detached from the transfer element (15).

10. Method for manufacturing a superstructure (7) with false teeth (8), designed to be mounted on at least one implant (9, 10) in the bone of a lower or upper jaw (1) in a person's oral cavity, and for manufacturing an aligning plate (3) with at least one opening (4) for drilling a bore hole (5) in the bone through the latter for mounting said implant (9,10), characterised in that a physical model (38) is made of said jaw (1) with at least one reference organ (2) which is fixed to a tooth, and in that a provisional model (39) of said superstructure (7) is made by means of this physical model (38), whereby a three-dimensional image is made of the jaw (1) together with said provisional model (39) and said reference organ (2), and whereby said three-dimensional image is electronically processed and the position of the anatomical structures (6) of said jaw (1) in relation to said reference organ (2) fixed to said tooth (12) is derived from this three-dimensional image, whereby a position and orientation are then selected for the implant (9,10) such that, when said bore hole (5) is being made, no critical anatomical structures (6) will be hit, and said aligning plate (3) is made with said opening (4) on the basis of the selected position and orientation, with an appropriate orientation and diameter making it possible to drill said bore hole (5) in the jaw (1) through said opening (4) such that no critical anatomical structures will be hit, whereby means are provided to the aligning plate (3) to fix it to the reference organ (2) and whereby said superstructure (7) is made by means of what is called a rapid prototyping technique starting from said provisional model (39) and the desired position and orientation of said implant (9,10) in relation to the reference organ (2).

11. Method according to any one of claims 1 to 10, whereby at least one marker (27) is provided on said reference organ (2), which marker (34) produces a high contrast in imaging techniques, whereby an image of the jaw (1) is formed by means of X-rays or magnetic resonance, or of a physical model (38) of said jaw (1), with the reference organ (2), whereby the position of the marker (34) in relation to the jaw (1) is determined on the basis of the image formed with said X-rays or via said magnetic resonance, and whereby the position of said reference organ (2) is then derived from the observed position of the marker (34).

12. Method according to any one of claims 1 to 11, whereby a support (4), preferably made of a material which is transparent to X-rays, with said marker (34) is fixed to said reference organ (2) in a detachable manner in the extension of a feed-through opening (23) of said reference organ (2), such that this support (4) extends in the prolongation of the feed-through opening (23) of the reference organ (2) and the marker (3) is situated at a certain distance (d) from the latter, whereby the position of the reference organ (2) is further determined on the basis of a predetermined distance (d) between said marker (34) and the reference organ (2).

13. Method according to any one of claims 1 to 12, whereby said image is formed by means of computer tomography.

14. Set with a transfer element (15), at least one reference organ (2) and at least one position transfer organ, characterised in that said reference organ (2) and said position transfer organ are fixed to each other in a detachable manner.

15. Reference organ (2) with fixing means to fix it to the surface of a tooth (12), characterised in that it comprises a spherical bearing area (22) with a central cylindrical feed-through opening (23) to be used as a support (33) for an aligning plate (3).

16. Reference organ (2) according to claim 15, whereby said fixing means are formed of a flat fixing plate (21) which is glued onto the surface of a tooth (12).

17. Reference organ (2) according to claim 15 or 16, whereby said feed-through opening (23) is provided with an internal screw thread.
